(19) United States
(12) Patent Application Publication
(10) Pub. No.: US 2011/0145047 A1
(43) Pub. Date: Jun. 16, 2011

(54) SYSTEM AND METHOD FOR APPLYING CREDITS FROM THIRD PARTIES FOR REDEMPTION AT MEMBER RETAILERS

(76) Inventors: Vijay Raghavan Chetty, Santa Monica, CA (US); Charles Frederic Paul, Incline Village, NV (US)

(21) Appl. No.: 12/909,603

(22) Filed: Oct. 21, 2010

Related U.S. Application Data
(60) Provisional application No. 61/285,911, filed on Dec. 11, 2009.

(51) Int. Cl. G06Q 30/00

(52) U.S. Cl. 705/14.17; 705/14.38

(57) ABSTRACT

According to one embodiment of the invention, an electronic device is adapted to receive and upload digital credits for later application as part of payment for purchases at particular retailer. The electronic device comprises a memory to store an incoming credit email message, and a processor that, in response to receipt of the credit email message and selection of a link contained on the credit email message, establishes communication with a storage area remote from the electronic device in order to upload a digital credit into an account of a registered user using the electronic device. The storage area is accessible by a plurality of retailers to allow the retailers, when the registered user of the electronic device is present at the retailer, to fetch and apply the digital credit to purchases at the retailer.

### CROSS-REFERENCE TO RELATED APPLICATIONS

This application claims the benefit of priority on U.S. Provisional Application No. 61/285,911 filed Dec. 11, 2009.

### 1. FIELD

Embodiments of the invention relate to the field of credit management. In particular, certain embodiments of the invention relate to a system and method for applying credits received from registered members of a credit redemption system to a recipient's holding account and making these credits available for redemption at one or more retailers that are registered with the credit redemption system.

### 2. GENERAL BACKGROUND

Even in today's digital world, many retail promotions distributed digitally, via the Internet and mobile technologies, are subsequently printed on paper by the recipient and presented to retailers for redemption. The rate of redemption of these promotions is extremely low. Moreover, billions of dollars worth of gift cards are purchased each year with a high percentage of these gift cards being lost, stolen and unused. Hence, a mechanism is needed that can enable the use of gift cards and digital promotional materials seamlessly and encourage people to visit retailers more regularly.

### BRIEF DESCRIPTION OF THE DRAWINGS

The invention may best be understood by referring to the following description and accompanying drawings that are used to illustrate embodiments of the invention.

FIG. 1 is a first exemplary embodiment of a Credit Redemption System (CRS).

FIG. 2 is a second exemplary embodiment of the Credit Redemption System (CRS).

FIG. 3A is an exemplary embodiment of the architecture of the electronic device of FIGS. 1 and 2.

FIG. 3B is an exemplary embodiment of operations for configuring the electronic device of FIG. 3A to support digital credit uploading into a centralized holding account for the recipient.

FIGS. 4A-4G are exemplary embodiments of POS controller and POS terminals that support digital credit uploading and redemption by the CRS.

FIG. 5 is an exemplary embodiment of the digital credit distribution process supported by the credit redemption system.

### DETAILED DESCRIPTION

Exemplary embodiments of the invention relate to a system and method for receiving digital credits by a recipient and making these credits available for redemption at one or more retailers that have joined a credit redemption system.

According to one embodiment of the invention, digital credits are given as gifts between registered users of a credit redemption system who are in communication over a network. The network may be a private network or a public network (e.g., the Internet) and the communications may be over a medium that supports wireless communications (e.g., infrared “IR”, laser, radio frequency, cellular, satellite, etc.) or wired communications (e.g., electrical wire, optical fiber, cable, etc.). After receipt of digital credits by one of the registered users (hereinafter referred to as a “recipient”), these digital credits are uploaded and remotely stored for later retrieval for redemption by a retailer that is also a registered member of the credit redemption system.

In the following description, certain terminology is used to describe certain features of the invention. For example, the term “retailer” constitutes an entity that is involved with the selling of items, namely products and/or services. An “electronic device” is a device that processes input data and supports network connectivity to upload digital credits into a credit storage unit (e.g., any local or remote device that provides data storage for monetary credits such as a server, dedicated hard disk drive array, etc.) that is accessible by one or more retailers. Examples of an electronic device include, but are not limited or restricted to a computer (e.g., desktop, laptop, netbook, mainframe with one or more terminals), a personal digital assistant, a cellular telephone, a kiosk, or the like.

The term “digital credit” generally describes pre-paid monies that may be applied to a balance owed or authorization to debit an account for an amount equivalent to the value of the digital credit. For instance, as an illustrative embodiment of the invention, the digital credit may be alphanumeric (or numeric-only) characters or even a string of bits that specify a monetary credit amount readable by a POS system.

According to another embodiment of the invention, digital credit may be an image that identifies a monetary credit value. For instance, the image may be a barcode in accordance with any one of the commonly accepted barcode formats such as Universal Product Code (UPC), EAN, Code 39, Code 128, GS1 DataBar, or the like.

Herein, the terms “logic”, “unit” and “module” constitute hardware and/or software. In general terms, hardware constitutes physical components while software constitutes code or a series of coded instructions that may be implemented as firmware or may be implemented as part of an operating system, an application program, a downloadable applet, a routine, or the like. For instance, a module can be stored in any type of machine readable medium and executed by a processing unit. Examples of “machine readable medium” include a programmable electronic circuit, a semiconductor memory device including volatile memory (e.g., random access memory, etc.) or non-volatile memory (e.g., any type of read-only memory “ROM”, flash memory), an optical disk (e.g., compact disk or digital video disc “DVD”), a hard drive disk, a portable drive (e.g., Universal Serial Bus “USB” flash drive), or the like. Examples of a “processing unit” comprise a digital signal processor, a general microprocessor, a micro-controller, a state machine, an application specific integrated circuit, or the like.

A. Exemplary System Architectures

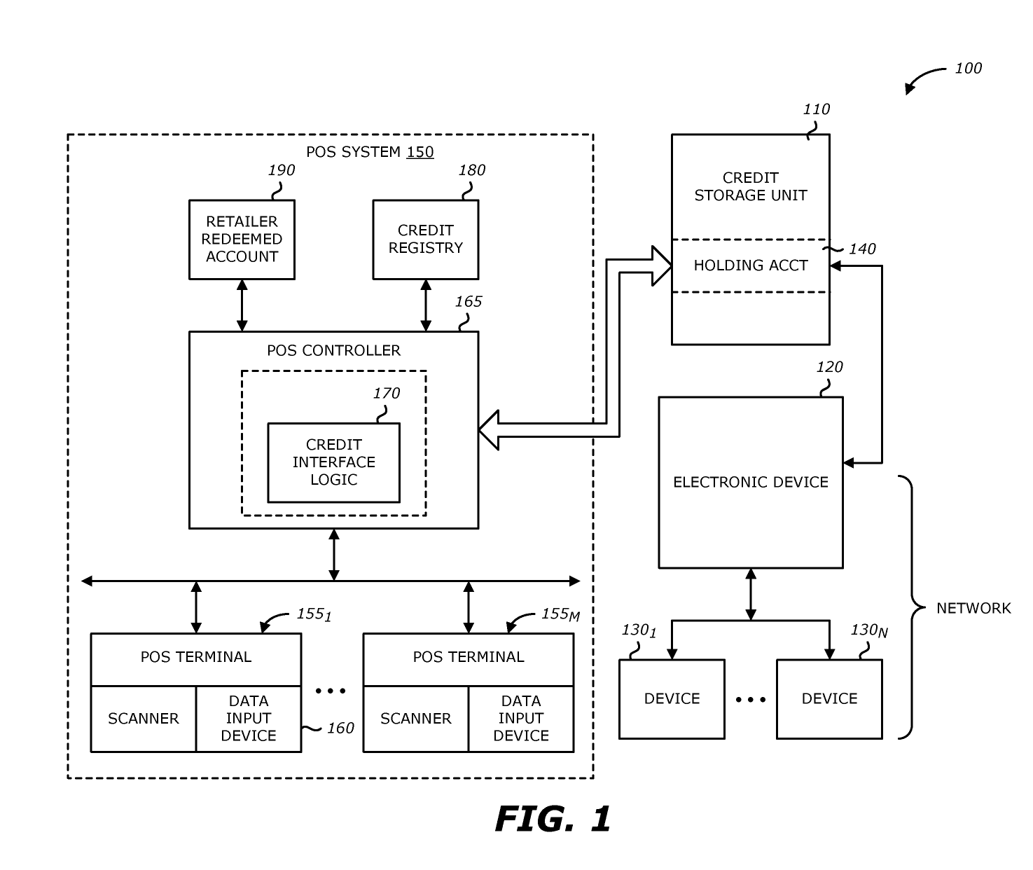

Referring now to FIG. 1, a first exemplary embodiment of a Credit Redemption System (CRS) 100 is illustrated. CRS 100 comprises a credit storage unit 110 that is in communication with and configured to receive and store digital credits uploaded by a registered user (hereinafter referred to as “recipient”) via an electronic device 120. As described below, at some point, the recipient is required to register with CRS 100. This may be accomplished by accessing a website and providing demographic and/or other information such as at least two or more of the following: name, age, electronic mail (email) address, mailing address, phone number, biometric (e.g., fingerprint image, retinal scan, facial geometry), funding source (e.g., credit card number, debit card number with pin, bank account routing number, PayPal® account, etc.), loyalty card number, personal identification number (PIN), and/or income range. Of course, in lieu of accessing the website, the user may register by simply filling out paperwork that is sent to an agency that registers the user.

According to this embodiment of the invention, after registration, a storage area 140 is allocated for the registered user (or group of users) within a credit storage unit 110. Herein, the user(s)-specific storage area 140 may be referred to as a “holding account.”

According to one embodiment of the invention, credit storage unit 110 constitutes one or more servers that not only are accessible by one or more retailers that are members of CRS 100, but also are adapted to store digital credits that are exchanged between registered users (e.g., provided by a registered consumer to a registered recipient). However, in lieu of a server implementation, it is contemplated that credit storage unit 110 may be any form of data storage that is accessible by a retailer and is configured to receive uploaded digital credits from a registered recipient who may be current, potential or former customers of the retailer.

As shown in FIG. 1, it is evident from the illustrative embodiment that digital credits may be routed over a network 135 that features electronic device 120 controlled by recipient and other electronic devices 130₁-130_{N} (N>1) controlled by various registered users. As a result, a member of CRS 100 is able to send an electronic mail (email) message from device 130ᵢ (i=1 . . . , or N) to the recipient associated with electronic device 120. This email message is referred to as a “credit email message” since, after the email is opened, it will enable the recipient to upload credits identified in the message into the recipient's holding account 140.

As an example, upon accessing a particular web site, a consumer may select to send a credit email message to be sent to the recipient. If the consumer is a registered member of CRS 100, the consumer will be able to access the web site, identify the intended recipient (e.g., email address and/or name of recipient), and the amount of credit to be given. As an optional feature, an existing funding source identified in the registration process may be selected or a different funding source may be selected or entered.

After this information is entered, the consumer will cause a credit email message to be sent to the recipient from which the credit amount can be uploaded into the recipient's holding account, provided the recipient is registered with CRS 100. The credit uploading process may be initiated upon selection of a link within the credit email message. The funding of the credit (i.e., debiting of the funding source selected by the consumer) can occur prior to transmission of the email message, once the credit is uploaded into the recipient's holding account, or when the credit is redeemed by the retailer.

As an alternative, before the credit amount is uploaded to the recipient's holding account, a verification process may be established to verify that the credit email message is in possession of the intended recipient. Such verification may be after establishing a secure communication path with credit storage unit 110 (e.g., secure socket layer “SSL” communication session). The verification may be in accordance with biometric information (e.g., fingerprint image) uploaded into credit storage unit 110, entry of a predetermined pass-phrase, or the like. It is contemplated, however, that the verification may occur prior to establishing a secure communication path with credit storage account 110. Such verification may be accomplished by a variety of techniques. For instance, the credit email message may feature an entry for the recipient to answer a question that the consumer knows the answer, has provided the answer when generating the credit email message and the answer has undergone a one-way hash function or other cryptographic operation to obfuscate the content of the answer.

According to another embodiment of this invention, besides allowing registered users to upload digital credits into holding account 140, it is contemplated that credit issuers (e.g., retailers, manufacturers and third parties) registered to participate in this credit network, may be given access to the users' holding accounts to load any credit directly into each user's holding account. Alternately, these credit issuers may electronically transmit their credits to credit storage unit 110 for subsequent distribution and allocation to the respective users' holding accounts based on certain criteria defined by the credit issuers. For instance, credits may vary depending on the amount of purchasing activity by each registered user (e.g., % rebates by some retailers, rewards, returns, refunds etc.).

Upon checkout, a point-of-sale (POS) terminal 155ⱼ (j=1 . . . , or M, where M≧1) identifies the recipient based on information received via a data input device 160 (e.g., keypad, touch screen, barcode or magnetic strip obtained via a card scanner). After such identification, POS terminal 155ⱼ signals a credit interface logic 170, which is controlled by POS controller 165, to fetch the digital credits retained in recipient's holding account 140. These digital credits may be stored locally at POS controller 165, may remain in holding account 140 and retrieved upon computing a subtotal (or total) purchase price, or transferred to another storage location that provides reduced fetching latency of credits by POS terminal 155.

According to one embodiment of the invention, where credit validation is not performed, credit interface logic 170 reviews the recovered digital credits for the registered recipient to see if the total purchase price exceeds the total amount of digital credits held by the registered recipient. If so, the total amount of digital credits is transmitted to POS terminal 155ⱼ for processing.

However, if the total amount of digital credits exceeds the total purchase price for the selected item(s), credit interface logic 170 transfers the digital credits equal to the total purchase price to POS terminal 155ⱼ and deducts the total purchase price from the total amount of digital credits. This difference is returned (i.e. uploaded) to the recipient's holding account 140 for future use. The applied digital credit is then added to the retailer's account of redeemed credits (hereinafter referred to as “retailer redeemed account 190”) for recordation of credit applied for accounting purposes (e.g., collection of monies owned by the controlling entity of credit storage unit 110, commissions paid to the controlling entity of credit storage unit 110, etc.).

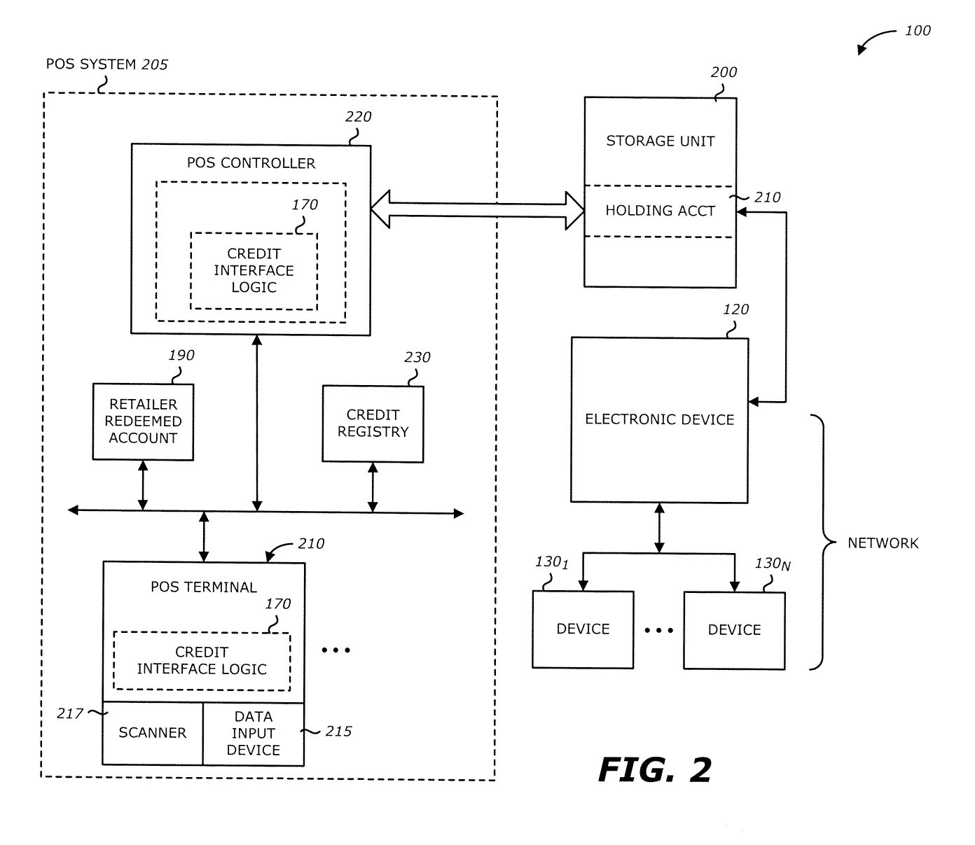

Referring now to FIG. 2, a second exemplary embodiment of Credit Redemption System (CRS) 100 is illustrated. CRS 100 comprises at least one storage unit 200 that are accessible by a point-of-sale (POS) system 205 that is implemented at the retailer. According to one embodiment of the invention, the retailer may be selected by the recipient to have access to recipient's holding account 140, although it is contemplated that access may be restricted by the recipient or made available to all retailers that are registered with CRS 100.

Herein, digital credits from the recipient are uploaded into credit storage unit 200 via electronic device 120 in response to selection of a link in a credit email message as describe above. Credit storage unit 200 may be local to the retailer or may be placed off-site.

Each user is assigned an amount of storage within storage unit 200. This amount of storage is referred to as the user's “holding account.” The digital credit may be subsequently accessed by a POS controller 220 or POS terminal 210 situated as part of retailer's POS system 205, depending on the POS configuration.

Upon checkout, POS terminal 210 identifies the recipient based on information received via a data input device 215 (e.g., keypad, touch screen, barcode or magnetic strip obtained via a card scanner) or scanner 217. After such identification, POS terminal 210 (or POS controller 220) fetches the digital credits that are assigned to the recipient and were previously uploaded in storage unit 200. The fetching of the digital credits may be performed by credit interface logic 170 implemented within POS terminal 210 (or POS controller 220) and optionally validated by such logic as described below.

1. Credit Validation by Credit Interface Logic

According to one embodiment of the invention, as items are scanned at POS terminal 210, credit interface logic 170 implemented at POS terminal 210 (or at POS controller 220) may be configured to validate the digital credits to the items purchased using credit registry 230 for example. As an illustrative example, credit interface logic 170 may be adapted to apply the credit as described in the ‘credit registry’ such as apply the credit only in certain select retailers, limit the amount of credit applied to any single purchase and/or limit how credits are applied (e.g., applied only for the purchase of selected items such as food products, excluding purchases of selected items such as cigarettes or alcohol, etc.). Examples of implementations of credit interface logic 170 may include, but is not limited or restricted to software uploaded into POS terminal 210, hardware implemented as part of POS system 205, or software executed by a processing unit within the POS controller 220.

When implemented with validation functionality, credit interface logic 170 may be further adapted to review the digital credits to see if ‘valid’ items from select retailers as described within the ‘credit registry’ have been purchased for redemption. When ‘valid’ items have been purchased from select retailers, logic 170 applies credits to the item and reduces the total credits held by the registered recipient by a corresponding amount. The applied digital credits are then added to retailer redeemed account 190.

In the event that an item required for the redemption of digital credits be voided or returned within the transaction, the credit redemption will be reversed, and the digital credits will be returned to the recipient's holding account. The digital credits also will be removed from the retailer redeemed account 190.

2. No Credit Validation

According to another embodiment of the invention, after identification of the user, credit interface logic 170 implemented within POS terminal 210 (or POS controller 220) fetches the digital credits previously retained in storage unit 200 for possible redemption. These digital credits are not validated by credit interface logic 170 since such validation functionality is not implemented. Rather, when present, the digital credits are merely downloaded to POS system 205 for subsequent redemption.

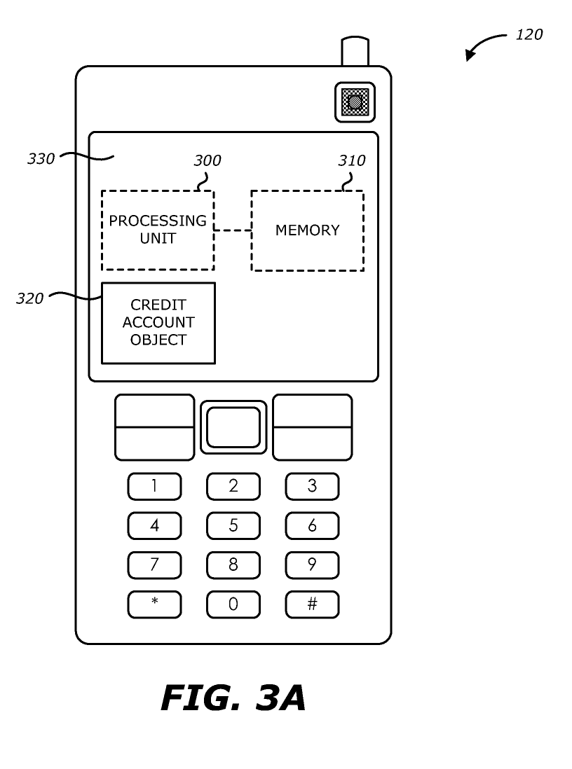

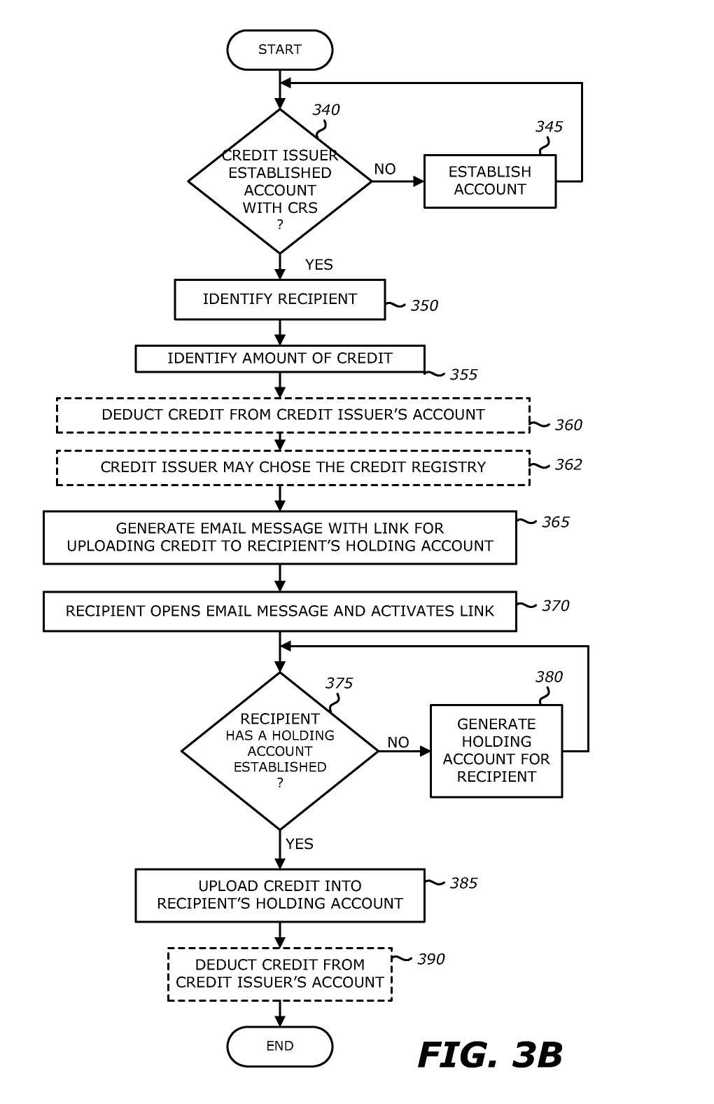

Referring now to FIGS. 3A-3B, exemplary embodiment of the architecture and operations for configuring electronic device 120 to support digital credit re-transmission is shown. With respect to FIG. 3A, electronic device 120 includes a processing unit 300 in communication with a memory unit 310. Memory unit 310 is a machine readable medium that is adapted to receive and store a software module (e.g., an application with an applet) that may be configured to generate an object 320 for display on a display screen 330 of electronic device 120 to more easily access and verify balances of the recipient's holding account. Object 320 may be used to receive, give and/or upload digital credits by establishing a secure communication path with credit storage unit 110/200 of FIGS. 1 and 2.

Herein, as shown in FIG. 3B, in order to provide credit to a targeted recipient, a registered user giving the credit (e.g., the credit issuer) needs to establish an account with the credit redemption system (CRS). This may be accomplished by visiting a prescribed website and selecting a registration icon or object. If an account is not established, the credit issuer needs to establish an account before proceeding (blocks 340 and 345). The account includes at least the name of the user, email address, a funding source (e.g., credit card number, debit card number with pin, bank account routing number, PayPal® account, etc.), and a personal identification number (PIN) or password.

After an account is established, the credit issuer identifies the recipient(s) by providing an email address of the targeted recipient(s) and identifies the amount of the credit to be applied to each recipient (blocks 350 and 355). It is contemplated that one or more recipients may be listed, and thus, a credit is available to each of the recipients. This feature may be advantageous when the user wants full visibility of equal gifts as credits being provided to the recipients. Alternately, the credit issuer may choose to issue different amount of credits to each of the selected recipients. Optionally, although not shown, the user may select a pass-phrase or validation question with a corresponding answer to confirm that the recipient receives the email message. Also, at this time, the amount of the credit may be optionally deducted from the credit issuer's selected funding source (block 360).

As an additional option, the credit issuer may choose the ‘Credit Registry’ (block 362). The ‘Credit Registry’ may include one or more retailers and/or service providers where the credits may be used. The ‘Credit Registry’ may further provide one or more items, group of items or a ‘category’ of items within each of those retailers or service providers for which the credits may be applied.

Thereafter, a credit email message addressed to the identified recipient(s) is sent (block 365). The credit email message includes a mechanism that enables uploading of the credit to the recipient's holding account.

According to one embodiment of the invention, upon the recipient opening the credit email message, a uniform resource location (URL) link is present (block 370). Upon selecting of the link, a secure communication path is established with the credit storage unit to determine if the recipient has established a holding account in the credit redemption system (block 375). If an account is not established, the recipient is prompted to establish an account and the recipient needs to establish an account before proceeding (block 380).

Thereafter, the credit provided by the credit issuer is uploaded into the recipient's holding account which is accessible by retailers that are members of the CRS (block 385). Optionally, at that time, the amount of the credit may be optionally deducted from the credit issuer's selected funding source (block 390) or perhaps when the recipient redeems the credit.

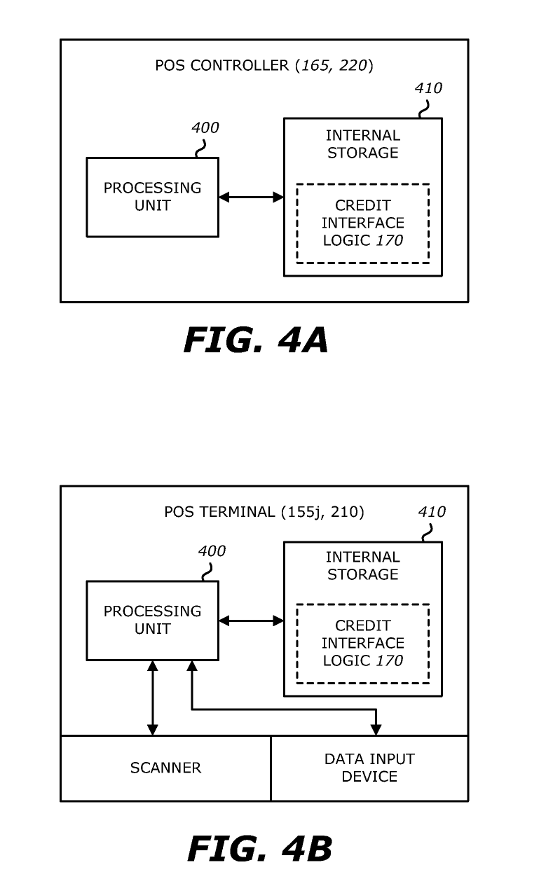

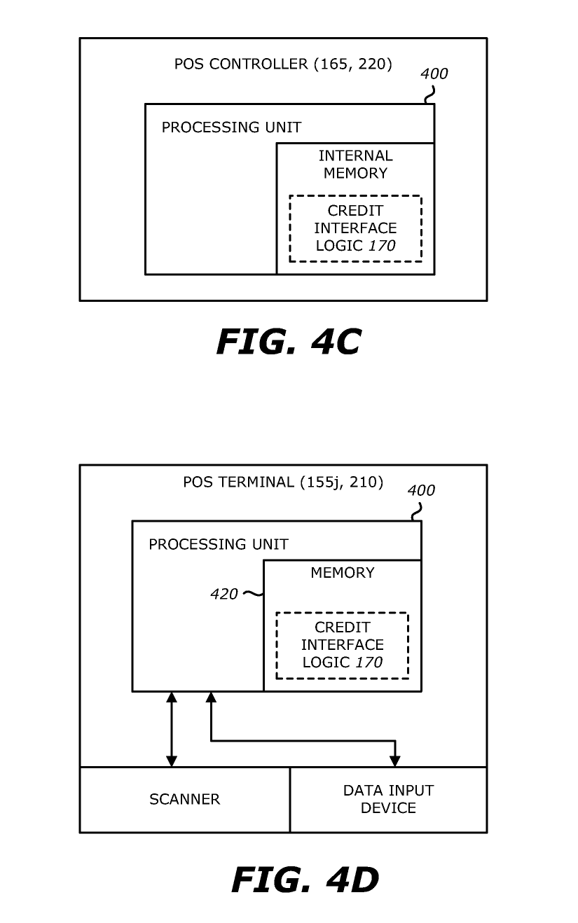

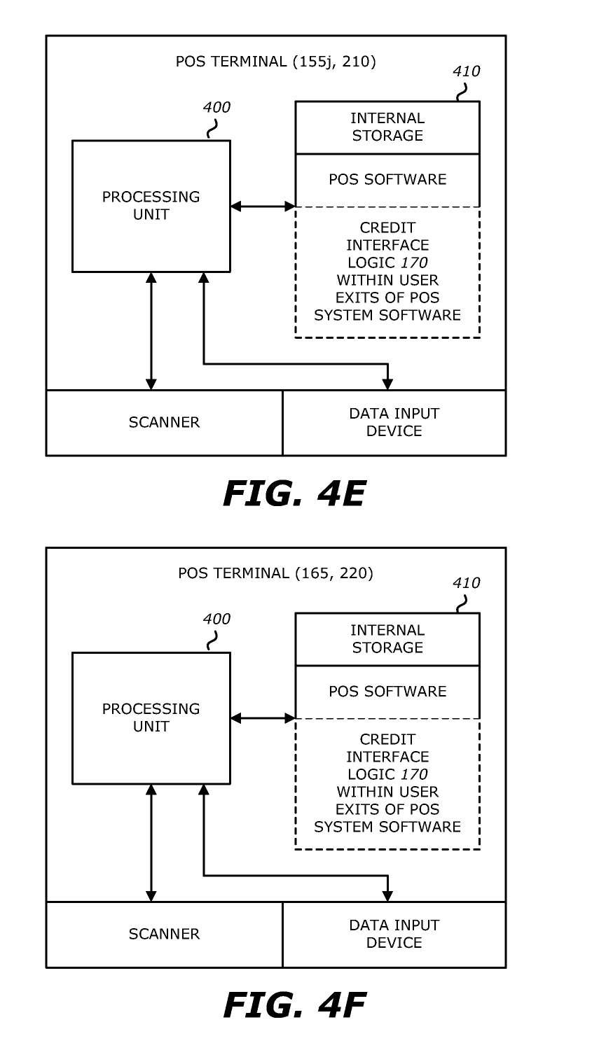

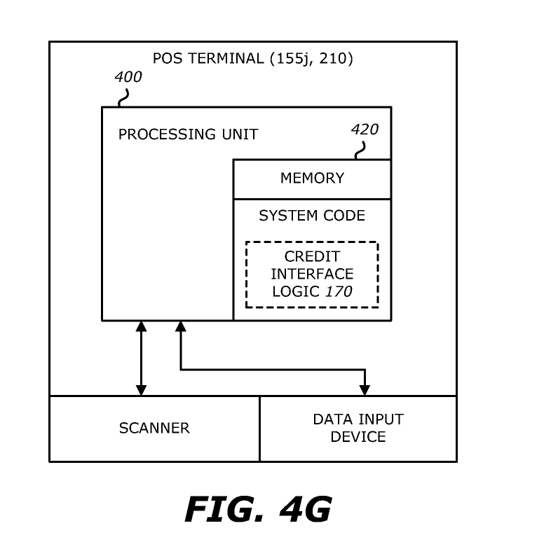

Referring now to FIGS. 4A-4G, exemplary embodiments of operations for configuring a retailer's POS system 150 of FIG. 1 or POS system 205 of FIG. 2 to support digital credit validation and clearance is shown. According to one embodiment of the invention, POS system 150 (or 205) comprises a controller 165 (or 220) that is adapted as a centralized processing unit for one or more POS terminals 155ⱼ/210. The implementation of credit interface logic 170 will vary based on the POS hardware and software being used by the retailer.

According to one potential implementation, as shown in FIGS. 4A and 4B, credit interface logic 170 may be a software module operating as a driver that is uploaded into internal storage 410 and executed by processing unit 400 of controller 165/220 (and/or each POS terminal 155ⱼ/210). Hence, controller 165/220 (and/or POS terminal 155ⱼ/210) can receive stored digital credits for an identified user.

According to another exemplary implementation, credit interface logic 170 may be a firmware that is installed in internal memory 420 of processing unit 400 implemented within controller 165/220 (and/or each POS terminal 155ⱼ/210) as shown in FIGS. 4C and 4D. Yet another exemplary implementation may feature the functionality of credit interface logic 170 being implemented within user exits of POS software on each POS terminal 155ⱼ/210 (and/or controller 165/220) as shown in FIGS. 4E and 4F. Yet another exemplary implementation, as shown in FIG. 4G, may include the functionality of credit interface logic 170 being implemented within system code that controls POS terminals 155ⱼ/210 of FIGS. 1 and 2.

Since the implementation will vary by POS system and in order to minimize its impact on the response times of POS system 150/205, credit interface logic 170 operates as a real-time interface to capture data from credit holding accounts and insert data into POS transactions. It may communicate with credit registry 230 for validation and decision making where implemented.

The data to be captured from POS transactions would be a transaction beginning and end, as well as any point where a total is performed; a transaction identifier; a POS number; a customer identification, such as a phone number, loyalty/club/frequent shopper card number, personal identification number (pin), credit card number, biometric data (e.g. fingerprint), or the like; purchased items including barcode number or PLU, quantity purchased, and unit price; credits redeemed; and voided items, credits, and transactions.

B. System Operation Flowchart

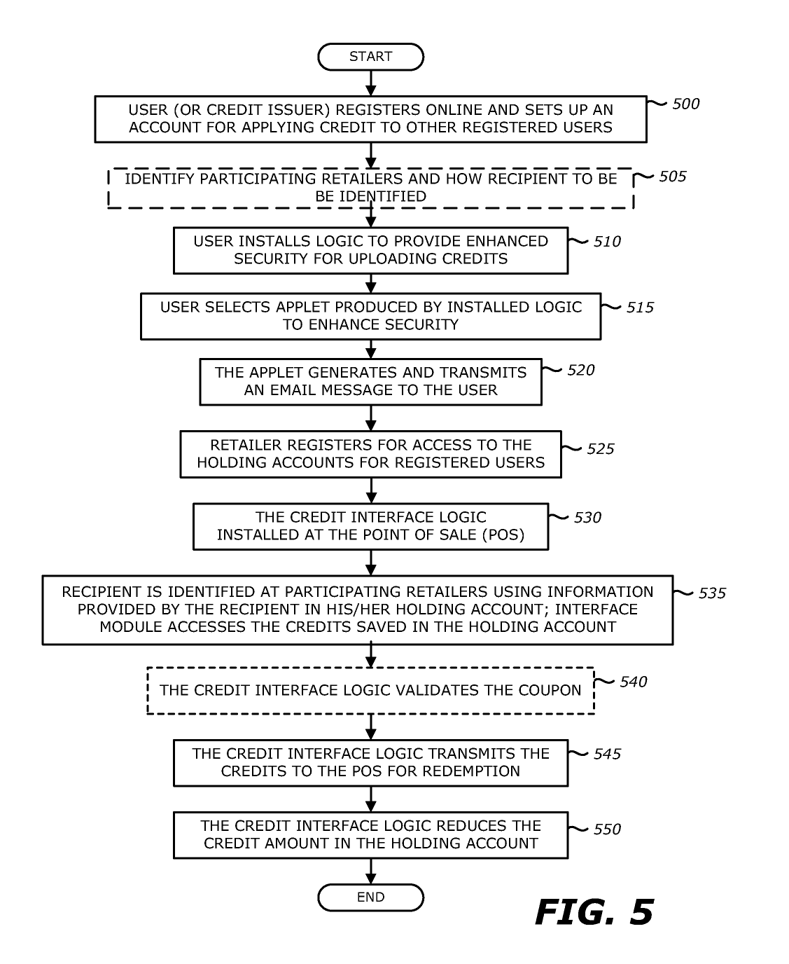

Referring to FIG. 5, an exemplary embodiment of the digital credit distribution and redemption process supported by the Credit redemption system is shown. First, the user registers with an entity to establish a credit holding account for retaining his/her digital credits (block 500). When setting up a credit holding account, the recipient may be allowed to select a ‘credit registry’ to identify the participating retailers where he or she intends to redeem credits and how the recipient shall be identified at these participating retailers (block 505). The method of identification may vary by retailer and includes one or more of the following: (1) retailer club/loyalty/frequent shopper card; (2) home telephone number; (3) mobile telephone number; (4) pin number; (5) biometrics (e.g. fingerprint); or (6) ATM/credit/debit card. After registration, the activation of a selected link within a credit email message would cause a secure communication path to be established between the electronic device and the credit storage unit to allow the credit to be applied to the recipient's holding account (item 520).

As an optional feature, the recipient may install logic on his/her electronic device to provide additional security to the credit transaction (block 510). As an illustrative example, a software application featuring an applet may be installed in the toolbox utility of the electronic device. According to one embodiment of the invention, the application may be downloaded from a website, although it is contemplated that the application may be downloaded from a portable recording medium (e.g., digital versatile disc “DVD”, compact disc “CD”, etc.). This application may include software underlying an applet that, when selected, provides enhanced security such as performing cryptographic operations on the credit information before transmission to the credit storage unit (block 515). These cryptographic operations may include encrypting the credit value, applying a digital signature recognized by the credit storage unit, or the like. Also, the application may allow the recipient easier access to his or her holding account.

In order to participate in the electronic redemption of digital credits, a retailer also registers with the CRS as a participating retailer (block 525). In addition, the retailer installs logic (e.g., credit interface logic) to function as an interface module and for communicating between the POS system at the retailer and holding accounts that are stored locally at the retailer or off-site (block 530). When implemented with validation functionality, this interface module will keep track of the items purchased and route the digital credits from the recipient's holding account.

When checking out at the retailer, the recipient identifies himself or herself at the POS terminal with one of the methods of identification that he has previously registered (block 535). At that time, the user identification is sent over a network connection to the holding accounts, and the credits previously retained in the user's holding account fetched for possible redemption.

As items are scanned/purchased on the POS terminal, the credit interface logic (also referred herein as the “interface module”) may be adapted to validate that the credits stored in the holding accounts are applied to the items to which the credits may be applied (block 540). If a ‘credit registry’ was selected, then the terms of the credit registry, such as the retailer and/or the items specified within the credit registry, may be validated with the retailer and the actual products purchased, to ensure that the terms of the credit registry are met, before the applicable credits are released to the POS system.

The interface module continually reviews the selected credits to see if ‘valid’ items from select retailers have been purchased for redemption. When ‘valid’ items from select retailers have been purchased to redeem a credit, the interface module transmits the credit to the POS terminal (block 545). The credit is then added to the retailer's redeemed credit account and the credit interface logic reduces the credit amount in the recipient's holding account by a corresponding amount (block 550). Where validation is not provided, the interface module merely downloads the recipient's digital credits to the POS terminal without the validation as described above.

Should an item required for the redemption of a credit be voided or returned within the transaction, the credit redemption will be reversed, and the credit will be returned to the user's holding account. The credit will be removed from the retailer redeemed account.

While the invention has been described in terms of several embodiments, the invention should not be limited to only those embodiments described, but can be practiced with modification and alteration within the spirit and scope of the appended claims set forth in the subsequent non-provisional application. The description is thus to be regarded as illustrative instead of limiting.

What is claimed is:

1. An electronic device comprising:
a memory to store an incoming credit email message;
a processor coupled to the memory, the processor that, in response to receipt of the credit email message and selection of a link contained on the credit email message, establishes communication with a storage area remote from the electronic device and accessible by a plurality of retailers to upload a digital credit into an account of a registered user using the electronic device, the digital credit being applied to purchases at any of the plurality of retailers.

2. The electronic device of claim 1, wherein the processor to determine if the account of the registered user has been established, and if not, the account is established after such determination and before uploading the digital credit.

3. The electronic device of claim 1, wherein the digital credit is restricted to the plurality of retailers.

4. The electronic device of claim 1, wherein the digital credit is restricted to only specific items provided by the plurality of retailers.

5. The electronic device of claim 1, wherein the digital credit is deducted from an issuer of the digital credit only after the digital credit is uploaded into the account of the registered user.

6. The electronic device of claim 1, wherein the digital credit is applied by a point-of-sale system at one of the plurality of retailers accessing the account and automatically deducting digital credits to offset a payable balance for purchases at the one of the plurality of retailers.

7. The electronic device of claim 6, wherein the digital credit is processed by either the point-of-sale system or a loyalty program integrated to operate with the point-of-sale system.

8. The electronic device of claim 1, wherein the digital credit is directed to and can be redeemed only for a particular category of items.

9. The electronic device of claim 1, wherein the digital credit is directed to and is redeemed only for one of the plurality of retailers.

10. Software embodied in a computer readable medium and executed by a processing unit implemented within an electronic device being part of a credit redemption system to perform the operations of:
establishing a communication with a remotely located storage area accessible by a plurality of retailers; and
uploading a digital credit to the remotely located storage from which such credits are subsequently downloaded to a point-of-sale system of one of the plurality of retailers for applying a credit to a purchase of an item at the one of the plurality of retailers.

11. The software of claim 10, wherein the establishing of the communication by the electronic device includes selecting an electronic link contained on a credit email message received over a network which automatically establishes communications with the storage area and uploads the digital credit into an account of a registered user to which the credit email message was sent.

12. The software of claim 10, wherein the digital credit is restricted to the plurality of retailers participating in the credit redemption system.

13. The software of claim 10, wherein the digital credit is restricted to only to the item provided by the one of the plurality of retailers.

14. The software of claim 10, wherein the digital credit is deducted from an issuer of the digital credit only after the digital credit is uploaded into the remotely located storage.

15. The software of claim 10, wherein the digital credit is directed to and can be redeemed only for a particular category of items.

16. The software of claim 10, wherein the digital credit is directed to and can be redeemed only for a first retailer of the plurality of retailers.

17. A method comprising:
(1) establishing a communication with a remotely located electronic device;
(2) receiving a digital credit from the electronic device for storage within a holding account assigned to a recipient of the digital credit; and
(3) downloading the digital credit to a point-of-sale system of one of a plurality of retailers having access to the holding account, the digital credit being applying to a purchase of an item at the one of the plurality of retailers.

18. The method of claim 17 further comprising:
uploading digital credits by a third party into the holding account.

19. The method of claim 18, wherein the digital credits are store credit.

20. The method of claim 18, wherein the digital credits are directed to and can be redeemed only for (i) a particular category of items or (ii) a first retailer of the plurality of retailers.

21. The method of claim 18, wherein the digital credits are directed to and can be redeemed only if the item purchased meets conditions established by an issuer of the credit.
